(19) United States
(12) Patent Application Publication
(10) Pub. No.: US 2012/0247984 A1
(43) Pub. Date: Oct. 4, 2012

(54) Secure Document Destruction Bin

(76) Inventors: Edward Jansson, Canton, GA (US); Jeffrey O. Smith, Dallas, TX (US)

(21) Appl. No.: 13/439,384

(22) Filed: Apr. 4, 2012

Related U.S. Application Data
(60) Provisional application No. 61/471,474, filed on Apr. 4, 2011.

(51) Int. Cl. B65D 85/00; G08B 1/08

(52) U.S. Cl. 206/216; 340/539.22

(57) ABSTRACT

A secure document bin is described that includes a bin having a lid that securely affixes to the bin to prevent unauthorized access to the contents of the bin, and an electronics module associated with the bin. The electronics module is formed in part by a location detection circuit and status sensors. The status sensors include a sensor to detect movement of the bin, a sensor to detect tampering with the bin, and a sensor to detect a relative fill level of the bin. The location and status of the secure document destruction bin is monitored by a monitoring center using wireless transmissions from the secure document destruction bin.

### CROSS REFERENCE TO RELATED INFORMATION

This application claims the benefit of U.S. Provisional Patent Application Ser. No. 61/471,474, filed Apr. 4, 2011.

### TECHNICAL FIELD

The present disclosure is directed to secure storage containers, and more particularly to a secure document destruction bin with remote monitoring.

### BACKGROUND OF THE INVENTION

Most companies have the need to destroy sensitive documents from time to time, but industrial shredders are expensive and using them for document destruction can be time consuming. An industry has evolved to meet this problem, where service providers will come to the company and take their confidential documents to secure locations where those documents are destroyed on an industrial scale. A problem arises in what to do with those documents while they are waiting to be collected by the service provider. Most companies and service providers employ either locked cabinets or locked mobile bins.

Cabinets are stationary and usually contain a removable bag behind a locked door or lid, while bins are mobile, usually a large trash type container on wheels, and use locking lids with a slot to insert documents. Bins have the advantage of being more secure than the cabinets as the entire bin can be removed and taken to the document destruction facility while remaining locked throughout. As the bins are mobile, however, they are subject to being moved, lost or tampered with. In addition, it is difficult to determine when a bin needs to be emptied, resulting in inefficient trips to collect half empty bins, or overstuffed bins that are not able to hold the required documents.

What is needed is a secure document bin that includes the ability to be remotely monitored to detect fill level and status of the bin.

### BRIEF SUMMARY OF THE INVENTION

In a preferred embodiment, a secure document bin is described. The secure document bin includes a bin having a lid that securely affixes to the bin to prevent unauthorized access to the contents of the bin, and an electronics module associated with the bin. The electronics module includes location detection circuits and status sensors, where the status sensors including a sensor to detect movement of the bin, a sensor to detect tampering with the bin and a sensor to detect a relative fill level of the bin. The location and status of the secure document destruction bin is monitored by a monitoring center using wireless transmissions from the secure document destruction bin.

In another preferred embodiment, a secure document bin is described that includes a bin having a lid securely affixed to the bin, the lid including a slot to allow the insertion of documents into the bin. A location determination module is operable to determine the location of bin, while a tamper sensor operates to detect the relationship of the lid to the bin. A motion sensor is operable to detect movement of the bin, and a fill sensor is operable to monitor the level of documents inside the bin, where the state of the tamper sensor, the motion sensor and the fill sensor reflect a status of the bin. Communications electronics associated with the bin are operable to send the location of the bin and the status of the bin to a monitoring center remote from the bin.

In yet another embodiment, a method of monitoring a secure document bin is described. The method periodically determines the location of the bin using a location determination module attached to the bin, and monitors a status of the bin, the status including the states of a tamper sensor operable to detect the relationship of the lid to the bin, a motion sensor operable to detect movement of the bin, and a fill sensor operable to monitor the level of documents inside the bin The status and location of the bin are periodically reported to a monitoring center.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a perspective view of an embodiment of a secure document bin according to the concepts described herein;

FIG. 2 is a block diagram of an embodiment of a system for monitoring the location and status of a secure document bin; and

FIG. 3 is a block diagram of an embodiment of an electronics module for a secure document bin having location and status determining capabilities.

### DETAILED DESCRIPTION OF THE INVENTION

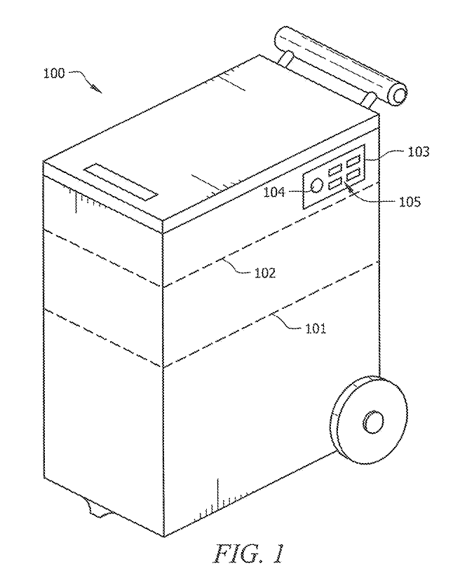

Referring now to FIG. 1, the present invention describes a preferred embodiment of a secure document destruction bin 100 that is able to wirelessly communicate its location and status to a monitoring center using an electronics module 103 incorporated into secure bin 100. The secure bin 100, either through embedded electronics or the electronics module 103 attached or incorporated into it, may include location determination capabilities using one or more of: satellite based location technologies, such as GPS, cellular based location services, or localized wireless infrastructure, such as RFID.

The bin 100 may additionally include tamper sensors and/or motion detection sensors that detect the opening or movement of bin 100, or other such activity that would indicate that someone is attempting to tamper with or take the bin. The electronics module 103 can include one or more buttons 104, which preferably includes a call button to alert the service company to retrieve the bin. Various displays or status indicators 105 can also be included. The displays and indicators can display any useful information and can include fill status, date that bin was placed in its current location and next scheduled service date.

The bin can also include electronics for determining the fill level 101 of bin 100. The level, along with location and status can be automatically reported to the service provider or third party monitoring center. A max fill line 102 can be set that automatically triggers a message to the service provider or monitoring center alerting them that it is time to retrieve the bin. The reporting of the location and status of bin 100 can be done through periodic transmissions by the electronics module 103 occurring at regular intervals or in response to status conditions, or can be done in response to a command or inquiry from the monitoring center.

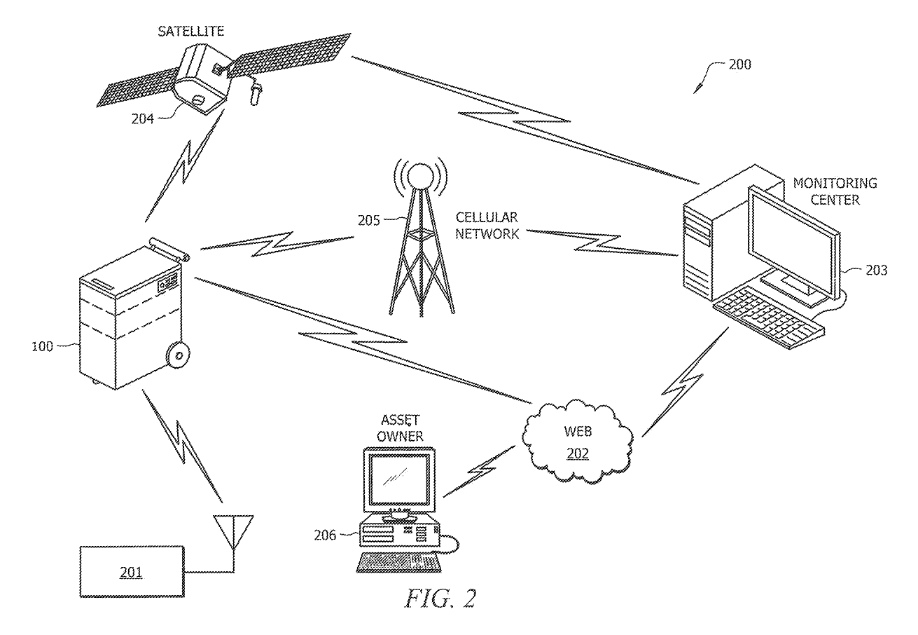

Referring now to FIG. 2, an embodiment of a system for monitoring a secure bin according to the concepts described herein is shown. The secure bin 100 includes electronics capable of communicating with one or more types of networks. In certain embodiments, the secure bin 100 or its associated electronics module would be able to receive GPS signals from satellite network 204 where they are available and send its location coordinates to a data center 203 using the cellular network 205, satellite communications, or other communications protocol. If the secure bin does not include GPS capabilities, then it could use other location determination techniques, such as location based services using cellular network 205, or location based infrastructure 201, such as RFID readers.

In addition to location detection capabilities, secure bin 100 has the appropriate electronics to communicate with a data center, or monitoring center, 203. The data center 203 receives the location information from the secure bin 100 using any type of appropriate communications network, such as satellite network 204, cellular network 205, or data network 202. Using the appropriate communications network, the secure bin 100 is able to communicate its location and status. The owner, or service provider, of the secure bin 100, asset owner 206, can retrieve location status and other data from data center 203 using a data network 202 connection.

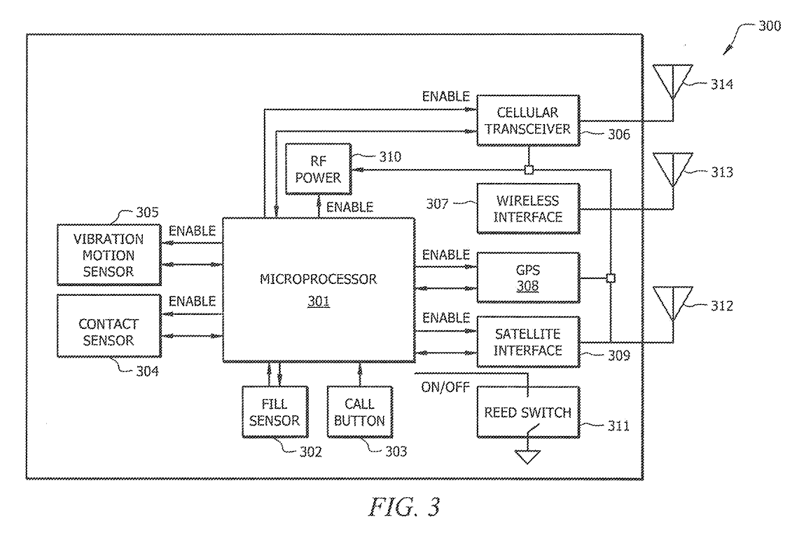

Referring now to FIG. 3, a preferred embodiment of an electronics module for use with a secure document bin according to the concepts described herein is shown. The module 300 includes a microprocessor 301 programmable to execute desired instructions and to control the operation of module 300. The processor 301 may have internal memory capable of storing data and programming information or may use memory external to the microprocessor. The module 300 also includes a cellular transceiver 306 and associated cellular antenna 314 to perform cellular communications. Power for the cellular transceiver is supplied by RF power module 310. The module 300 also includes a satellite location determination device 308, which can be GPS or satellite service based, and a satellite interface 309, which can be a transmitter, receiver or transceiver, which uses satellite antenna 312. Wireless interface 307 controls communication with wireless data networks, such as wifi or bluetooth, using antenna 313.

Fill sensor 302 detects the level of paper within the bin. Fill sensor 302 can be contact sensors, short range radar sensors, or other type of sensor that can be used to gauge the paper level in bin 100. Call button 303 sends a signal to the monitoring center using the appropriate communications network. The signal indicated that the bin is full and needs to be serviced or retrieved. Vibration sensor 305 and contact sensor 304 can be embedded in or connected to the device to detect motion and lid status. Other sensors can also be included that detect other bin attributes or environmental information. Such information can be collected and reported to the data center or can also be used to trigger actions by the mobile device. Reed switch is an electrical switch that is activated by a magnetic field and can be used to enable or disable the device.

The location and status information of the bin can be periodically reported to a monitoring center, either at regular intervals or upon the occurrence of a particular event. Embodiments of the secure bin can also be programmed to receive information from the monitoring center, such as software and program updates.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A secure document bin comprising:
a bin having a lid that securely affixes to the bin to prevent unauthorized access to the contents of the bin; and
an electronics module associated with the bin, the electronics module including a location detection circuit and status sensors, wherein the status sensors including a sensor to detect movement of the bin, a sensor to detect tampering with the bin and a sensor to detect a relative fill level of the bin, wherein the location and status of the secure document destruction bin is monitored by a monitoring center using wireless transmissions from the secure document destruction bin.

2. The bin of claim 1 wherein the electronics module further comprises a call button, the call button operable to send a service notice to the bin's service provider.

3. The bin of claim 1 wherein the tamper sensor is a contact sensor between the lid and the bin.

4. The bin of claim 1 wherein the location detection circuit is a GPS module.

5. The bin of claim 1 wherein the wireless transmissions to the monitoring center are cellular transmissions;

6. The bin of claim 1 wherein the wireless transmissions to the monitoring center are data network transmissions.

7. A secure document bin comprising:
a bin having a lid securely affixed to the bin; the lid including a slot to allow the insertion of documents into the bin;
a location determination module operable to determine the location of bin;
a tamper sensor operable to detect the relationship of the lid to the bin;
a motion sensor operable to detect movement of the bin;
a fill sensor operable to monitor the level of documents inside the bin, wherein the state of the tamper sensor, the motion sensor and the fill sensor reflect a status of the bin; and
communications electronics associated with the bin, the communications electronics operable to send the location of the bin and the status of the bin to a monitoring center remote from the bin.

8. The bin of claim 7 wherein the location determination module, the tamper sensor, the motion sensor, the fill sensor, and the communications electronics comprise an electronics module.

9. The bin of claim 8 wherein the electronics module is integral to the bin.

10. The bin of claim 8 wherein the electronics module is securely attached to the bin.

11. The bin of claim 7 wherein the electronics module further comprises a call button, the call button operable to send a service notice to the bin's service provider.

12. The bin of claim 7 wherein the tamper sensor is a contact sensor between the lid and the bin.

13. The bin of claim 7 wherein the location detection circuit is a GPS module.

14. The bin of claim 7 wherein the wireless transmissions to the monitoring center are cellular transmissions;

15. The bin of claim 7 wherein the wireless transmissions to the monitoring center are data network transmissions.

16. A method of monitoring a secure document bin, the method comprising:
periodically determining the location of the bin using a location determination module attached to the bin;
monitoring a status of the bin, the status including the states of a tamper sensor operable to detect the relationship of the lid to the bin, a motion sensor operable to detect movement of the bin, and a fill sensor operable to monitor the level of documents inside the bin; and
periodically reporting the location and the status of the bin to a monitoring center.

17. The method of claim 16 wherein the location detection circuit is a GPS module.

18. The method of claim 16 wherein the wireless transmissions to the monitoring center are cellular transmissions;

19. The method of claim 16 wherein the wireless transmissions to the monitoring center are data network transmissions.

20. The method of claim 16 wherein the periodic reporting of the location and status is done in response to a query from the monitoring center.
